(19) United States
(12) Patent Application Publication
(10) Pub. No.: US 2017/0061210 A1
(43) Pub. Date: Mar. 2, 2017

(54) INFRARED LAMP CONTROL FOR USE WITH IRIS RECOGNITION AUTHENTICATION

(71) Applicant: INTEL CORPORATION, Santa Clara, CA (US)

(72) Inventor: MIKKO OLLILA, Tampere (FI)

(73) Assignee: INTEL CORPORATION, Santa Clara, CA (US)

(21) Appl. No.: 14/836,801

(22) Filed: Aug. 26, 2015

(51) Int. Cl. G06K 9/00; G06T 7/00; H04N 5/262; H04N 5/232; H04N 5/33; H04N 5/225

(52) U.S. Cl. CPC G06K 9/00604; H04N 5/33; H04N 5/2256; G06K 9/0061; G06K 9/00617; H04N 5/2628; H04N 5/23293; G06T 7/0051

(57) ABSTRACT

Infrared lamp control is described for use with iris recognition authentication. In one example, an eye of a face is detected using a user facing camera. A position of the detected eye with respect to an infrared (IR) camera is determined. The IR camera has a field of view and the detected eye does not fill the field of view of the IR camera. A time of exposure by the IR camera for the portion of the IR camera field of view filled by the detected eye is determined. The eye is then illuminated by activating an IR lamp during the time of exposure and deactivating the IR lamp after the time of exposure.

### FIELD

The present description pertains to the field of iris recognition for authentication and in particular to an infrared lamp for illuminating a user's iris.

### BACKGROUND

In some high security installations, an image of the iris of a person is captured by a camera in order to allow or permit access to a building, an area, or equipment such as a computing console. A person's iris is more unique than a person's fingerprint and an iris scanner is harder to fool than a fingerprint reader. While such systems are often referred to as iris scanners, modern versions are more commonly in the form of infrared cameras. The modern system is typically large and expensive because it requires an infrared light to illuminate the eye and a camera capable of capturing an infrared image with enough detail to make a reliable authentication determination. Infrared light provides a much more detailed image of an iris than does visible light. In addition, an imaging processor is used to compare the captured iris with stored approved images and to determine if there is a match. Some sort of estimation process is used to account for dirt on a user's eyeglasses, contact lenses, eye diseases, broken blood vessels in the eye, variations in lighting, and other factors that may change the appearance of the iris.

Iris scanning is available as an additional authentication, password, or other security feature in smart phones and may be extended to other types of portable and handheld devices including computers. The iris scanner may be used as a supplement or as an alternative to fingerprints. Smart phones add iris scan by adding another front facing camera to the front side of the mobile device next to the normal front facing “selfie” camera and an IR lamp to illuminate the iris. The iris scan camera uses a special IR pass filter while the normal camera uses a visible light spectrum pass filter. The authentication process is performed using the processing and memory resources already available on the smart phone.

A large, slow, high power iris scanning system may enhance security for a building by slowing access. These same characteristics may render a handheld or portable device frustrating to use. For smart phones and notebook computers, the trend is for small, fast, low power systems that provide only a very small obstacle to using the device. The conventional fixed installation is not suitable for use as an add-on to the portable or battery-power device.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a block diagram of an iris recognition system with IR lamp enhancements according to an embodiment.

FIG. 2 is a diagram of a portable device incorporating an iris recognition system according to an embodiment.

FIG. 3 is a diagram of a portable device showing an image on a display to assist user iris recognition according to an embodiment.

FIG. 4 is a diagram of a portable device showing another image on a display to assist user iris recognition according to an embodiment.

FIG. 5 is a process flow diagram of controlling the duty cycle of an IR lamp according to an embodiment.

FIG. 6 is a process flow diagram of controlling the illumination area of an IR lamp according to an embodiment.

FIG. 7 is a diagram of an IR lamp with an adjustable illumination area according to an embodiment.

FIG. 8 is a diagram of the IR lamp of FIG. 7 with the housing and lens move up to narrow the illumination area according to an embodiment.

FIG. 9 is a diagram of the IR lamp of FIG. 7 with the reflector moved down to narrow the illumination area according to an embodiment.

FIG. 10 is a hybrid timing command and image sensor diagram of exposure using an iris scanning system according to an embodiment.

FIG. 11 is a block diagram of a computing device incorporating IR lamp enhancements according to an embodiment.

### DETAILED DESCRIPTION

Iris recognition systems use an infrared (IR) camera to capture an image of one or both retinas or to scan one or both retinas. A variety of different camera configurations may be used. While scanners have been used commonly, rolling shutter cameras are now available in compact and low priced systems. CMOS (Complementary Metal Oxide Semiconductor) and CCD (Charge Coupled Device) image sensors are both very sensitive to infrared light so an infrared camera is easily made using existing sensors and an infrared light pass through filter.

A clear picture of an iris is more reliably obtained when an IR LED (Light Emitting Diode) lamp or projector is used to light the human iris. The iris texture is easiest to detect when the light spectrum is around 820 nm. The IR lamp works well with a simple camera in dark environments, such as indoors or at night. This is in part because modern interior lighting systems are designed to minimize IR radiation which manifests as wasted heat.

In outdoor environments or when close to a window, the sun's substantial IR illumination will cause reflections onto the iris typically from many different directions at the same time and the sunlight is reflected from many different surfaces into the eye. The reflections can cause false detections and incorrect iris textures on the image. The sun reflections can overwhelm an iris scan system unless the IR lamp is brighter than the sunlight reflections. Iris scan may work properly up to about 10,000 lux (10 klux). However, a sunny day can be as high as 100 klux. In a highly reflective location such as a lakeside, a sandy or a snowy location, the general illumination level may be as high as 130 klux. This requires additional illumination power from the IR lamp in order for the system to deliver reliable and frequent scans.

The portable device user want an iris scan system work each time after the user shuts down the display and wants to press a button to use the device again. The user also wants the device to be able to make several authentication attempts in rapid succession. The user may want to make several authentication attempts when the user blinks or holds the iris scanner in the wrong position. At the same time many small inexpensive IR LEDs are low intensity and require current of 400 mA or more. This is a high current for smart phone or similar device. An IR scan operation may require three 20 second sessions to initiate and may still require multiple 10 second exposure for regular logins. If the user switches the device off and on frequently, then the LED may have a high duty cycle. The heavy use of the LED leads to extensive heating of the LED which requires some type of cooling system. It may also present a significant battery drain.

As described herein the IR LED on time is controlled so that it is only on during the moments when the irises are actually being exposed. This reduction in on time may be used to reduce the size or complexity of the heat sink and to extend the amount of time that the IR LED may be used.

As also described herein the light beam of the IR LED may be focused on the location of the eyes. In other words, the illumination from the IR LED may be zoomed depending on the distance from the camera to the iris. For a close eye a wider light beam is used and for a more distant eye a narrower light beam is used. Controlling the field of view of the lamp allows more of the IR LEDs illumination to strike the eye or even the iris. The increase in intensity caused by focusing a beam of light is related to the square of the zoom ratio. So if the FOV is narrowed by one third, then the intensity of the focused beam is nine times larger. This means that the LED may be smaller or operate at lower power reducing the heat and the power consumption.

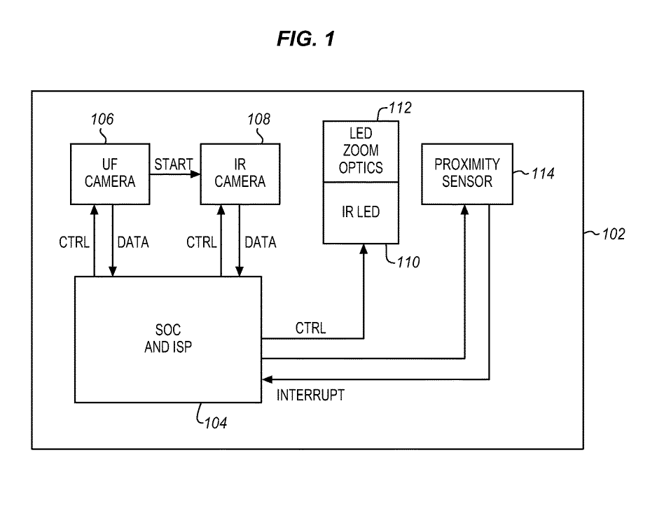

FIG. 1 is a block diagram of parts of a portable device, such as a smart phone, a notebook computer, a tablet, or a wearable with an iris recognition system. As mentioned the iris recognition system may be used for user authentication, login, purchases, and other purposes. The device 102 uses an SOC (System on a Chip) 104 with an integrated central processor, ISP (Image Signal Processor), and memory. The SOC is coupled to a primary UF (User Facing) camera 106 and an IR camera 108. The SOC controls the operations of the cameras using a control line to each camera and receives images from the cameras over a data line from each camera for processing by its internal ISP. The connections are shown for illustration purposes. There may be many parallel lines, a shared bus or a variety of other types of connections between the cameras and the SOC. There may also be additional interface and other intermediate devices between the cameras and the SOC. Alternatively, the functions of the two cameras may be combined into a single camera. While an SOC is shown, any of a variety of different system architectures may be used with more or fewer components. The system may also include a larger mass memory, additional sensors, user input devices, wired and wireless data interfaces, and actuators as well as displays and a battery, among other components.

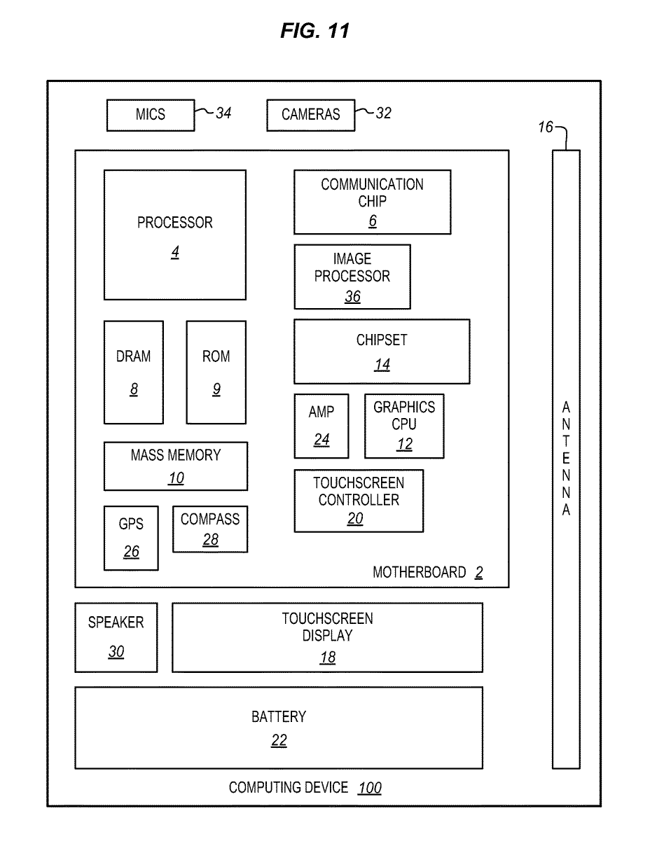

In addition the system includes an IR lamp with an LED 110 or other source of IR light and an optical system 112 for zooming, focusing, or both. The IR lamp is controlled by and coupled to the SOC so that the operation of the IR lamp may be coordinated with the operation of the IR camera. The optical system may also be controlled by the SOC to control the amount of zooming based on results from either or both of the cameras. An optional proximity sensor 114 is also coupled to the SOC. There may also be additional components, not shown here in order to simplify the drawing including a user facing visible light LED or other illumination source of the UF camera. Additional cameras on other surfaces of the device, position and motion sensors and more as shown for example in FIG. 11.

The UF camera 106 may optionally have a START line connection to the IR camera 108. This may be a two-way connection, a multi-node bus or a direct single line, depending on the particular implementation. The START line may be used to signal the start of a new frame capture signal for iris scanning. In this way the UF camera may as a master for the iris camera. A hardware START or synchronization signal ensures that an image captured from the UF camera is taken at about the same time as the image from the iris camera the UF camera image may then be used to change setting for the next IR camera image such as LED zoom 112 settings, illumination settings, cropping, etc. The SOC may then uses the UF camera image to obtain a better iris scan with each frame.

Many systems have a proximity sensor. For smart phones, the proximity sensor is used to turn off the display when the phone is face down or being held against the user's face for handheld telephone use. The same kind or another kind of proximity sensor may be used to detect if the user is too close to the IR lamp for eye safety reasons. Focusing the light beam from the IR lamp will increase the intensity proportional to the square of the zoom ratio. So a zoomed beam at one third of the normal field of view will increase the intensity within that narrower beam by 9 times or extend the range proportionally. The proximity sensor may also be used as a range finder and as an activation system so that authentication only begins when something is near the cameras.

A proximity sensor provides a very low power but imprecise component to determine distance and the nearness of another object. The same functions may instead be performed by either one of the cameras. Alternatively, the proximity sensor may include a rangefinder or distancing system to not only detect the presence of something near the sensor but also its approximate distance. The proximity sensor may also be substituted with a low resolution camera. Such a camera may be used to provide depth information for use with the regular UF or IR camera. The proximity sensor may also be used in addition to any one or more of these components.

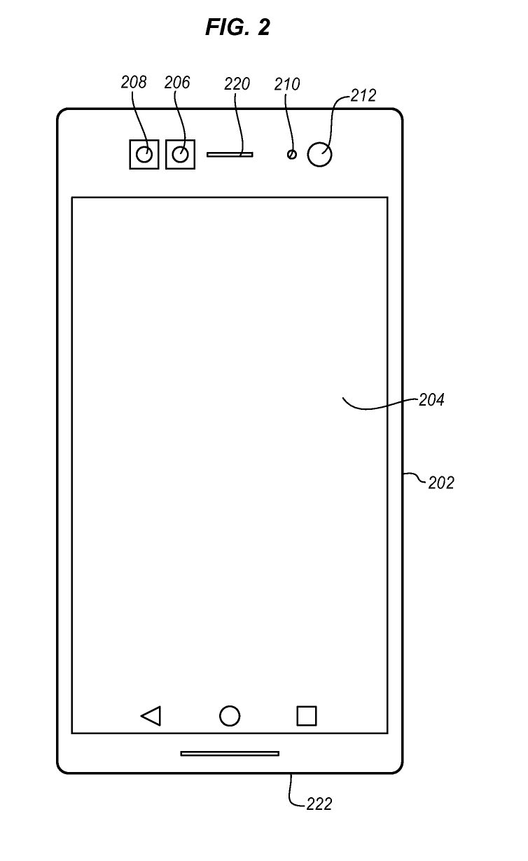

FIG. 2 is a diagram of an exterior front surface of a handheld device, such as a smart phone, similar to that of FIG. 1. The device may be a smart phone, a tablet, a portable computer, a smart watch or adapted into any of a variety of other form factors and configurations. The device 202 includes a display 204 which may include touch interface for user input. On one surface of the device proximate the screen a primary user facing (UF) camera 206 is mounted. The UF camera is directed in the same direction as the display and is able to capture images of the user when the user is in front of the screen. The UF camera may also display images that it captures on the display. On the same surface, the device also includes an IR camera 208, a proximity sensor 210, and an IR lamp 212. There may be additional cameras on this surface and other surfaces (not shown) as well as additional lamps, camera flash LEDs and other sensors.

The system also includes a speaker 220 and a microphone 222 as shown. There may be multiple speakers and microphones on this and other surfaces. The device may also have buttons and ports (not shown) for additional functions as well as keyboards, connectors, and other input and display devices, depending on the particular implementation. While the cameras, proximity sensor and IR lamp are shown as all being on the same one edge of the screen, they may be placed in other positions to suit different form factors and user activities. In addition, as mentioned above, the cameras, proximity sensor, and lamps may be combined in different ways to provide a more compact or less expensive device.

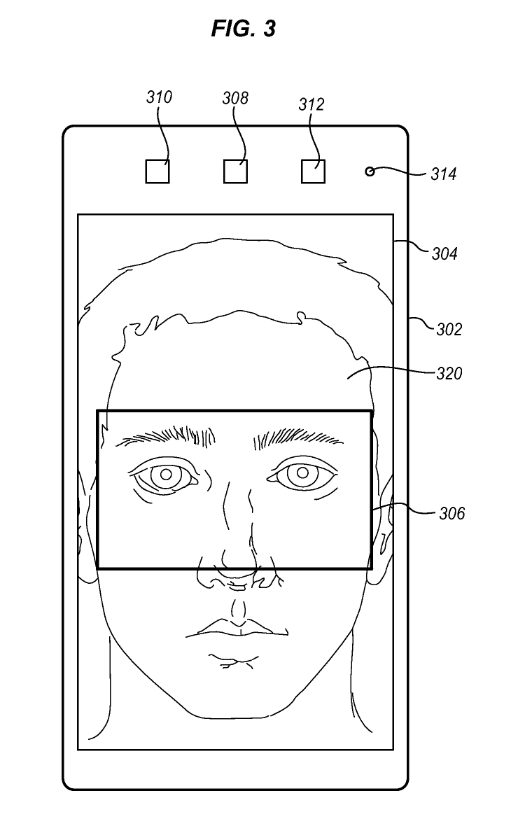

FIG. 3 is a diagram of a portable device 302 to show how the display may be used to aid in iris recognition. The device 302 has a front facing display 305 proximate a front facing UF camera 308. A user has positioned his head or the device so that his head substantially fills the field of view of the front facing camera. The display shows an image of the user's head 320 that the front facing camera observes through its field of view. This view is combined with an alignment frame 306 superimposed over the image and also presented on the display. Using the alignment frame the user may adjust his head or the device so that the image of his eyes are within the displayed alignment frame.

The device may be configured so that the display corresponds to the aspect ratio, orientation, and field of view of the UF camera while the alignment frame corresponds to the aspect ratio, orientation, and field of view of an IR camera 310. As shown, the cameras may be configured so that the fields of view are different and the aspect ratios are rotated by 90 degrees or a quarter circle. In this example the UF camera is in a portrait or vertical mode while the IR camera is a landscape or horizontal mode with a smaller total field of view. This allows the width of the IR cameras field of view to be less than the width of the UF camera's field of view and also a little less where the width is the large dimension of the IR camera but the small dimension for the UF camera. The height of the IR camera's field of view is much less than the height of the UF camera's field of view.

When the user's eyes are within the alignment frame, and IR lamp 312 may be activated to illuminate the user's eyes within the alignment frame and the IR camera 310 then captures an image of the user's eyes and in particular the iris of one or both eyes.

The alignment frame aids the user in placing his eyes in a proper position with respect to the IR camera. The iris recognition by the IR camera may be started by the user pressing a button or touching the touchscreen display or it may be started by the device. In one example, a proximity sensor 314 determines the user is near to the display and therefore the IR camera. The UF camera then analyzes the image that it receives on its sensor and when it detects that the user's eyes are within the field of view corresponding to the IR camera, and then it activates the iris recognition process with the IR lamp and the IR camera.

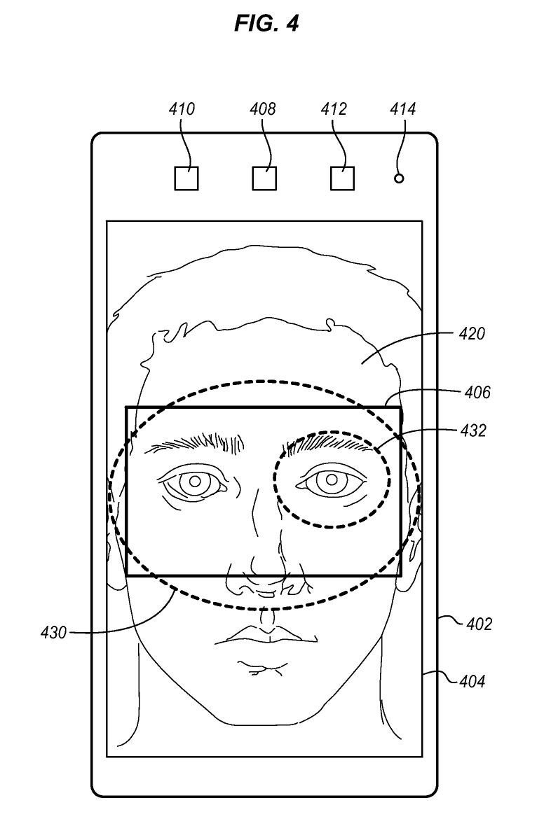

FIG. 4 is a diagram of a device 402 similar to that of FIG. 3 with a display 404, a UF camera 408, IR camera 410, IR lamp 412, and optional proximity sensor 414. The display shows that a user has positioned his head 420 and the device so that his eyes are within the alignment frame 406 for the IR camera. The device is therefore ready to perform an iris recognition using the IR lamp and the IR camera. In some cases, to scan an iris, the user person must come close to the camera and hold the relevant eye still without blinking long enough for the camera to capture an image of the iris. The display as shown including the alignment frame aids the user in doing this.

In order to illuminate the entire area of the alignment frame which represents the field of view of the IR camera, the IR lamp must illuminate an area 430 that is as wide and as tall as the IR camera's field of view. However, the user's eyes will not fill this entire area. As a result, the IR lamp is consuming more power and generating more heat than is necessary for iris recognition. The area 432 of a user's eye is only a fraction of the total area. By illuminating the area filled by one eye of the user, the amount of power and heat may be significantly reduced. Even if both eyes are to be illuminated, the amount of illumination required for the lamp may be reduced.

As shown in FIG. 1, the IR lamp may have a light source 110 and a lens system 112. For a single eye iris image a different beam focal length 432 may be used focus is used than the beam focal length 430 for an image of both eye irises. This may be accomplished using the lens system 112 of the lamp. The light beam focal length may also be adjusted based on the distance of the face from the IR lamp. In another embodiment, the IR lamp may have two light sources such as LEDs, one for each eye. This allows a smaller LED to be used and it allows the light to be concentrated on the area of interest even when both irises are scanned. The system may be configured to switch between a one LED and a two LED mode depending on the scan being used at any particular time.

The distance of the iris from the IR camera can be detected in a variety of different ways. This can be used to zoom the IR lamp. The distance may also be used to determine whether the user's eye is close enough to the IR camera to obtain a good iris scan. The distance may be detected from an autofocus system of the UF camera, the proximity sensor, from a second depth camera (not shown), or from a dual aperture camera. In one embodiment, the IR camera may be used as a second camera for depth determinations. In another embodiment, the distance is determined using the size of the iris on the image sensor of either one of the cameras as measured in pixels. The iris of a human is the same size all over the whole world. Thus based on the size of the iris image in pixels, the distance of the iris from the camera can be calculated using known information about the camera system such as the focal length, image circle size and other parameters using lens maker's equations.

Once the eyes are detected from the UF or IR camera stream using eye or face detection techniques in the ISP, CPU or other resource, the corresponding rows of the image sensor of the IR camera can be determined. The IR lamp pulse may be set for the moment during which the relevant rows are being exposed. Outside of the exposure time of those rows the IR lamp may be turned off.

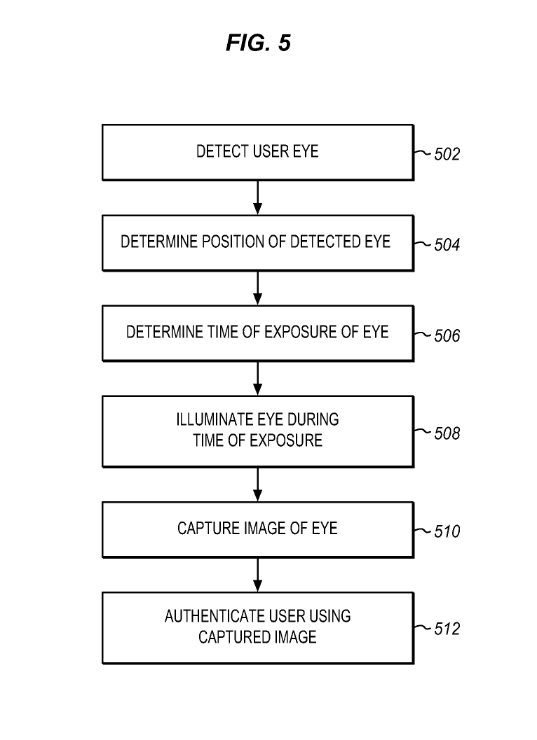

The exposure timing of the IR and UF camera can be very different, e.g. the frame rate can be different. For example the IR camera exposure can be much longer and only the part of the image or region of interest in the image (ROI) wanted to be exposed is cropped. FIG. 5 is a process flow diagram of controlling the duty cycle of an IR lamp or flash for an image of an iris. At 502 the user's eye is detected. This may be done on any user facing camera whether the full color visible light camera or the special IR camera. One or more cameras captures images as a stream and sends the image stream to the ISP, CPU or other processor for face recognition. In another example, the system detects the user's face or eye by receiving a command from the user. In this example, the user aligns his face with the camera and then pushes a button or touches a control indicating that his face is aligned.

As mentioned above the face or eye detection process may be aided by a proximity sensor that determines when an object is within range for an iris scan. The UF or IR camera may then be activated to determine if the object is a user's face and whether there is an eye within the camera's field of view. Alternatively, the camera may be activated by a motion or acceleration sensor on the device. In this way when the user picks up the device to unlock it, the device will be activated and ready to perform authentication.

In another approach the eye may be detected with the user working in cooperation with the system. The process may begin by the user holding the device in front of the user's face or the user moving his face into view of the UF camera. A view of the user facing the camera is then shown on a display proximate the user facing camera. The system then shows an alignment frame in a central area of the display as shown, for example, in the previous drawing figures. The user then is able to position the eyes within the alignment frame. The system determines when an eye of the face is within the alignment frame and then determines the distance and position for the iris image to be captured. The IR lamp is activated for the iris image capture after the eye is within the alignment frame and the position and distance of the iris is determined.

At 504 the position of the detected eye or the position of the eye on the detected face is determined. The position may be compared to the field of view of the IR camera to determine whether the eye is within range and an iris scan may be performed. If the iris scan is for two eyes, then a similar analysis may be made to determine whether both eyes are within the camera's field of view.

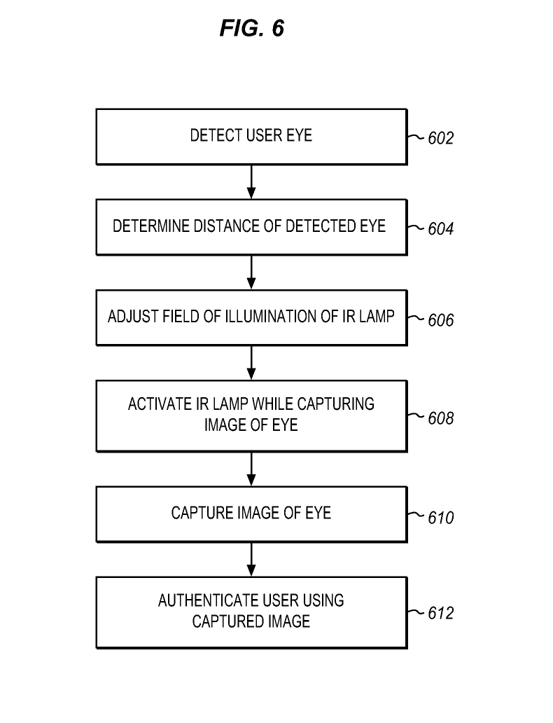

Typically, the eye will not fill the entire field of view of the IR camera. As a result, when the IR camera captures an image, only some of the pixels of the IR camera's image sensor will actually include the user's iris. Once the eye is detected, the pixels that include the iris can be determined. This may be done by analyzing an image from the IR camera or one from the UF camera and then relating the pixels of the UF camera to the pixels of the IR camera. The identified pixels for the iris will typically belong to a particular row and column of the IR image sensor. The power consumption and heat generated by the IR lamp can be reduced if the IR lamp is adjusted only to illuminate the pixels corresponding to the iris. This may be done by limiting the amount of time that the IR lamp is on as in FIG. 5 or by directing the light from the lamp to the iris as in FIG. 6. These two techniques may be used independently of each other or combined for even greater benefit.

At 506 the time of exposure is determined for the pixels of the IR camera that include the iris. For many digital image sensors, especially compact and low priced image sensors, the photodetector values picked up by each pixel of the sensor is sampled individually. In other words the pixels are sampled one after the other or a single row will be sampled at the same time in parallel and each row is sampled separately in a sequence. This is typically referred to as a rolling shutter as compared to a global shutter. As a result, during the course of an image capture, if the iris only will be imaged in one quarter of the rows of the IR camera, then imaging the iris will only use one quarter of the total exposure time. The time taken to expose the other rows will not add to the image of the iris.

First the system determines when the relevant pixels will be sampled. Then the system configures the IR lamp to be on only when those pixels or rows are being sampled. An additional few rows may be added to the on time of the lamp to accommodate any timing, warm up, or synchronization issues. In other words, the system first determines the rows of the sensor of the IR camera that correspond to forming an image of eye. Based on this information, the system is then able to determine time at which these rows will be sampled or when the rolling shutter will be open for these rows.

At 508 the exposure is taken and the IR lamp is used to illuminate the iris during the exposure. Instead of being switched on during the entire IR image, the IR lamp illuminates the eye only for the relevant pixels or rows of pixels. This can be done using the determined exposure times determined at 506. The IR lamp is off other than during these eye or iris exposure times, saving power and reducing heat.

At 510 the IR camera has captured an image of the eye during the exposure with the IR lamp illuminated as necessary. The IR camera or a later processor is also able to crop the captured image to eliminate all but the eye or all but the iris. In some embodiments, since the rows containing the eye have already been determined, all of the other rows may be cropped out the image. This reduces data transfer and processing requirement for analyzing the captured iris.

At 512 the user is authenticated using the captured image. Iris authentication may be performed using any of a variety of techniques that compare the captured image to previously captured images directly or indirectly using an appropriate technique. The captured image of the iris may be compared to images of authorized users or an abstraction of particular distinctive features of the iris may be used.

While this process is described in the context of detecting an eye and capturing an image of an eye, only the iris is required for a typical iris recognition system. There are many eye detection and face detection techniques and any one or more of these may be used to advantage herein. Having determined a position for the eyes, the position of the iris may easily be determined. The entire eye may be imaged or only the iris. However, in any of the described examples, the system may determine iris positions without explicitly determining eye positions or even face positions.

FIG. 6 is a process flow diagram for zooming an IR lamp or flash based on a distance determination. At 602 the user's eye or even the user's iris is detected. This may be done in the same way as described above for operation 502.

At 604 the distance from the IR camera to the user's eye is determined. The device may have several different systems for determining the distance. In some system, the UF camera may have an autofocus sensor. This system directly or indirectly determines for which to set the focus distance of the lens for the UF camera. This distance may be used as the distance reference for the IR lamp. Some system may have a proximity sensor that is able to determine distance such as with a rangefinder, sonar or other type of distance sensor. In some systems, there are one or more additional cameras physically displaced from the UF camera that are used as a depth camera. The image of the depth camera is compared to that of the UF camera to determine distances to points in the image. This depth camera may be the IR camera or third camera. In some systems, the UF camera or another camera has a dual aperture system that allows depth to be determined. Even without any of these additional hardware components, the distance may be determined based on the size of the iris of the eye that is to be imaged.

At 606 the field of illumination of the IR lamp is adjusted based on the determined distance. If the iris is near then a wider field of illumination is used. If the iris is far, then a narrower filed of illumination is used. This allows the illumination to be directed at the iris without too much spill over onto other areas of the user's face and the surrounding environment. The field of illumination may also be referred to as the field of view of the optical system for the IR lamp. The field can be adjusted by adjusting a reflector behind the light source, by adjusting an optical system in front of the light source or by adjusting the size of a channel that carries the light, or in any of a variety of other ways.

The idea of the adjustment of zooming is to adjust the field of illumination to cover only the eye or the iris of the eye of the detected face. This approach may be improved still more by providing a circular or elliptical field of illumination for the IR lamp. The IR lamp is then shaped to resemble the shape of an eye or iris. By using two lamps two eyes may be illuminated at the same time without illuminating the nose in between or the cheeks on either side.

At 608 the IR lamp is activated while capturing an image of the eye using the IR camera. The image is captured at 610 and used to authenticate the user at 612. These last two optional operations may be the same or similar to the last two operations of FIG. 5 above.

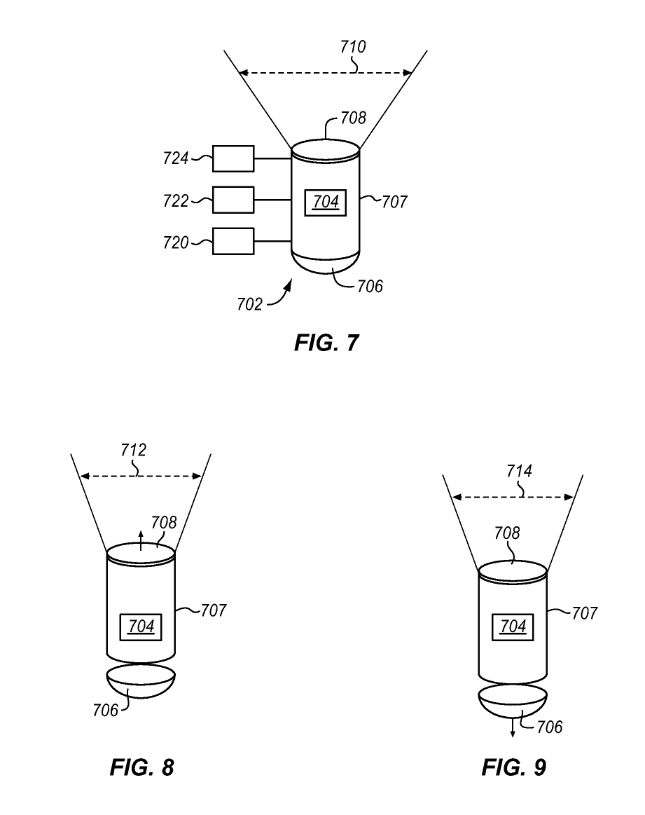

FIG. 7 is an example of an IR lamp 702 suitable for use as described herein. The lamp has a central LED light source 704 in a housing 707 with a lower reflector 706 and an optional upper objective lens 708. Instead of a lens, the lamp may use a diffuser, a collimator or any suitable optical device for directing light in an intended direction. The LED light source with the reflector, housing, and lens directs the illumination in a particular field 710 having an angle or arc as it exits the housing. The reflector has an actuator 720 to allow the reflector to be moved towards and away from the LED. The housing has an actuator 722 to allow the housing to move vertically up and down so that the end of the housing is closer or farther away from the LED. The lens 724 similarly has an actuator 724 to allow the lens to be moved towards and away from the LED.

Any one or more of these actuators may be used to adjust the field of illumination 710 of the lamp. The lamp system may have or use only one of these systems or all three. The lens or reflector or both may be attached to the housing so that moving the housing moves the lens or reflector or both. The lens may have a different system for modifying the field of illumination and multiple optical elements may be used to form the lens which may or may not move with respect to each other.

FIG. 8 shows that the housing and lens may be moved vertically up away from the reflector and the LED to reduce the field of illumination. In a similar way, the housing or lens or both may be moved down to increase the field of illumination. FIG. 9 shows that the reflector may be moved down away from the lens and LED to reduce the field of illumination. Similarly, the reflector may be moved up to increase or broaden the field of illumination. The actuators are not shown in order to simplify the drawing. The lamp of FIGS. 7, 8, and 9 is provided only as an example other techniques and structures may be used to adjust the field of illumination.

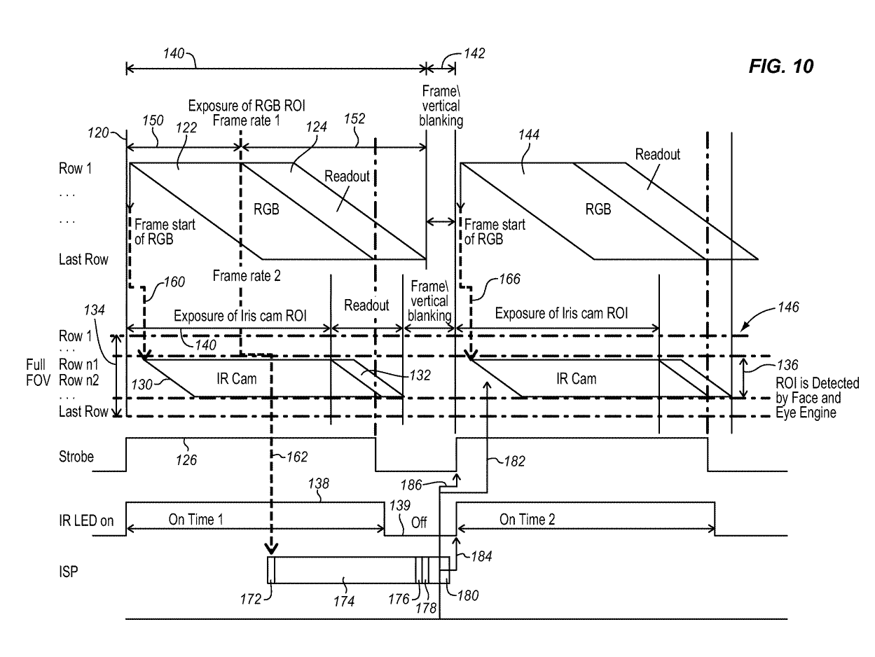

FIG. 10 is a hybrid timing, command, and image sensor diagram of an exposure using the iris scanning system as described herein according to one implementation. Two image captures or exposures from both cameras are shown on a horizontal time axis from left to right. The exposure cycle begins at an initial time 120. At this time the primary or UF camera takes an exposure 122 across its image sensor from Row 1 to its Last Row to cover its entire field of view. This continues until the captured image is read at 124. The readout is also row-by-row from Row 1 to the Last Row. The view may then be displayed on the screen (not shown) of the device to aid the user in aligning his eye with the iris recognition system. The angled sides of the exposure and readout show that the rows the sensor indicated vertically are each captured in sequence from top to bottom and similarly these rows are read from top to bottom. The angled sides are indicative of a rolling shutter commonly used with small camera modules for portable devices. This is provided as an example. Any other type of shutter may be used as an alternative.

The UF camera exposure may be accompanied by the activation of a strobe 126, xenon flash, or any other light in the visible range to assist the UF camera in capturing detail in the image. The UF camera may be referred to as an RGB camera if it captures color images in red, green, and blue pixels.

At the same time the IR camera may also capture an exposure 130 which is afterwards read out 132. The capture and read out are also shown in the form of a rolling shutter exposure with rows being read in sequence as indicated by the diagonal slope of the sides of the exposure and readout. The IR camera has a field of view 134 which is wider than the iris that is to be captured. Accordingly, there may be a cropped field of view 136 from Row n1 to Row n2 that is actually captured or actually illuminated by the IR lamp. The rows above and below the cropped field of view may not be captured at all or they may be captured and then cropped from the image before the IR camera transmits the iris image for processing.

The IR lamp is activated at 138 to illuminate the iris for imaging until the imaging of the cropped field of view is completed. The IR lamp is then deactivated 139 or turned from ON to OFF. This allows the IR lamp time to cool. The RGB strobe 126 is also turned off when the RGB capture is completed. In the present example, the IR camera starts later and finishes later so that the IR LED is turned off shortly after the RGB strobe.

The illumination and capture correspond to an exposure time 140. The exposure time has an exposure time 150 and a readout time 152. This is followed by a frame blanking 142 during which the image sensors and the strobe and IR lamp are turned off. The cycle may be repeated 144 after this with the same RGB imaging and IR camera imaging followed by another blanking period 146. This cycle may be repeated until the iris is successfully imaged. The RGB camera may be used to aid the user in positioning the eye as well as to detect face, iris, distance and other parameters and features. These parameters and features may be used to better guide and control the IR camera.

As shown, when the RGB camera starts capturing an image, there is a frame start signal 160 sent from the RGB camera to the IR camera to start the IR camera exposure 130. This also triggers the IR LED to switch on 138. The signal is sent at the beginning of the exposure 120. The precise timing of the signal may be adapted to suit the relative exposure duration for the two cameras. If the IR camera is faster or has fewer rows so that it has a shorter exposure time, then the RGB camera as the master may insert a delay between the start of the two cameras. This is shown in the timing between the first camera exposure 122 and the second camera exposure 130. In this way the exposures of the two cameras are synchronized. As mentioned previously, there may be a hardware start signal as shown in FIG. 1, or the signal may come from an imaging processor.

When the first row of the RGB camera is finished with the exposure time 150, the readout time 152 begins. The readout is started by a second start of frame (SOF) signal 162 to the image signal processor (ISP) or any other suitable device for collecting the image. The ISP marks the SOF 172 and then collects the transmission 174 of pixels for each row of the RGB camera during the RGB readout period 152. After this is completed an end of frame (EOF) marker 176 is placed by the ISP or received from the RGB camera. This is followed by the horizontal blanking interval 178 of the rolling shutter which is followed by the vertical blanking interval 180 of the rolling shutter. In the same way the ISP can collect the pixels from the IR camera. In one embodiment, these are captured in the same buffer at the same time for a single combined transmission 174 in which the rows of both cameras are compiled into a single file. After the completion of the blanking intervals, a new SOF 166 is signaled by the RGB camera or the ISP to initiate the next sequence.

During the blanking interval, the received images may be evaluated as described above to determine whether the iris has successfully been captured. The rows of the IR camera that are best suited to iris recognition can be re-evaluated or evaluated for the first time if this is the first image. This may be used to adjust the zoom of the IR LED and to adjust exposure or cropping of the IR camera. The ISP may send a control signal 182 to the IR camera to change parameters or settings based on the previous exposure. The ISP may similarly send a control signal 184 to the IR LED to adjust its on time, zoom, brightness and other factors. The ISP may also send control signals 186 to the visible light strobe to increase or decrease output to enhance the output of the RGB camera. Using this control loop with images going to the ISP and then the ISP sending control signals back to the cameras during the blanking interval and before the next frame, each subsequent frame will match better with position of the user's eyes. As described herein, iris scanning may be reliably performed in bright outdoor environments. At the same time the distance from the IR camera at which an iris can be imaged is increased in both indoor and outdoor environments by better directing the illumination at the true region of interest. The power consumption of the IR LED is also reduced which allows for less expensive or fewer LEDs to be used to illuminate the iris. In addition a smaller heat sink may be used. The number of consecutive usages of the iris scanner is also increased.

FIG. 11 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 including any depth sensors or proximity sensor are coupled to an optional image processor 36 to perform conversions, analysis, noise reduction, comparisons, depth or distance analysis, image understanding and other processes as described herein. The processor 4 is coupled to the image processor to drive the process with interrupts, set parameters, and control operations of image processor and the cameras. Image processing may instead be performed in the processor 4, the cameras 32 or in any other device.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes detecting an eye of a face using a user facing camera, determining a position of the detected eye with respect to an infrared (IR) camera, the IR camera having a field of view, wherein the detected eye does not fill the field of view of the IR camera, determining a time of exposure by the IR camera for the portion of the IR camera field of view filled by the detected eye, and illuminating the eye by activating an IR lamp during the time of exposure and deactivating the IR lamp after the time of exposure.

In further embodiments determining a position of the eye comprises determining rows of a sensor of the IR camera corresponding to forming an image of the eye.

In further embodiments determining a time of exposure comprises determining when illumination of the determined rows is sampled.

In further embodiments the IR camera has a rolling shutter and wherein determining a time of exposure comprises determining when the rolling shutter is open for the determined rows.

In further embodiments determining a position of the detected eye comprises capturing an image stream from the user facing camera and analyzing the image stream to detect the eye.

Further embodiments include capturing an image of the eye during the exposure and authenticating the face using the captured image.

In further embodiments authenticating comprises identifying an iris for the eye of the face in the captured image and comparing the captured image of the iris to images of authorized users.

In further embodiments capturing an image of the eye comprises capturing an image of a portion of the face and cropping off the portion that does not include the iris of the eye.

Further embodiments include determining whether a distance from the face to the IR camera is within a range and wherein illuminating the eye comprises illuminating the eye only if the determined distance is within the range.

In further embodiments detecting an eye of a face comprises showing a view of the user facing camera on a display proximate the user facing camera, showing an alignment frame in a central area of the display, and determining when an eye of the face is within the alignment frame.

Some embodiments pertain to an apparatus that includes a user facing camera to detect an eye of a face an infrared (IR) camera having a field of view, a processor to determine a position of the detected eye with respect to the IR camera, wherein the detected eye does not fill the field of view of the IR camera, and to determine a time of exposure by the IR camera for the portion of the IR camera field of view filled by the detected eye, and an IR lamp to illuminate the eye, the IR lamp activating during the determined time of exposure and deactivating after the determined time of exposure.

Some embodiments pertain to a portable device that includes a display, a memory, a user facing camera proximate the display to detect an eye of a face, an infrared (IR) camera having a field of view, a processor to determine a position of the detected eye with respect to the IR camera, wherein the detected eye does not fill the field of view of the IR camera, and to determine a time of exposure by the IR camera for the portion of the IR camera field of view filled by the detected eye, and an IR lamp to illuminate the eye, the IR lamp activating during the determined time of exposure and deactivating after the determined time of exposure, wherein the processor is further to authenticate the user based on an image of the eye captured during the determined time of exposure and to provide the authenticated user access to the memory.

Some embodiments pertain to a method that includes detecting an eye of a face using a user facing camera, determining a distance of the detected eye with respect to an infrared (IR) camera, adjusting a field of illumination of an IR lamp based on the determined distance, and activating the IR lamp while capturing an image of the eye using the IR camera.

In further embodiments determining a distance comprises using an autofocus sensor, a proximity sensor, a depth camera, a dual aperture system of a second camera or by measuring the size of an iris of the eye.

In further embodiments adjusting a field of illumination comprises adjusting a lens between the IR lamp and the eye, adjusting a reflector of the IR lamp, or adjusting the field of illumination to cover only the eye of the detected face.

In further embodiments detecting an eye of a face comprises, showing a view of the user facing camera on a display proximate the user facing camera, showing an alignment frame in a central area of the display, and determining when an eye of the face is within the alignment frame, and wherein determining a distance and activating the IR lamp comprise determining the distance and activating the IR lamp after the eye is within the alignment frame.

In further embodiments the user facing camera is a visible light camera oriented to capture an image that is taller than it is wide and wherein the infrared camera is oriented to capture an image that is wider than it is tall.

In further embodiments the IR lamp comprises two light sources one for each of two eyes, the method further comprising determining whether an image of both eyes of the face is to be captured and wherein activating the IR lamp comprises activating the two light sources.

Some embodiments pertain to an apparatus that includes a user facing camera to detect an eye of a face, an infrared camera to capture an image of the detected eye, an IR lamp to illuminate the detected eye during the image capture of the IR camera, a sensor to determine a distance of the detected eye with respect to the infrared (IR) camera, an actuator to adjust a field of illumination of the IR lamp based on the determined distance, and a processor to activate the IR lamp while capturing an image of the eye using the IR camera.

Some embodiments pertain to a portable device that includes a user facing display, a user facing camera proximate the display to detect an eye of a face, an infrared camera to capture an image of the detected eye, an IR lamp to illuminate the detected eye during the image capture of the IR camera, a sensor to determine a distance of the detected eye with respect to the infrared (IR) camera, an actuator to adjust a field of illumination of the IR lamp based on the determined distance, and a processor to activate the IR lamp while capturing an image of the eye using the IR camera and to authenticate the user for use of the portable device using the captured image of the eye.

What is claimed is:

1. A method comprising:
detecting an eye of a face using a user facing camera;
determining a position of the detected eye with respect to an infrared (IR) camera, the IR camera having a field of view, wherein the detected eye does not fill the field of view of the IR camera;
determining a time of exposure by the IR camera for the portion of the IR camera field of view filled by the detected eye; and
illuminating the eye by activating an IR lamp during the time of exposure and deactivating the IR lamp after the time of exposure.

2. The method of claim 1, wherein determining a position of the eye comprises determining rows of a sensor of the IR camera corresponding to forming an image of the eye.

3. The method of claim 2, wherein determining a time of exposure comprises determining when illumination of the determined rows is sampled.

4. The method of claim 2, wherein the IR camera has a rolling shutter and wherein determining a time of exposure comprises determining when the rolling shutter is open for the determined rows.

5. The method of claim 1, wherein determining a position of the detected eye comprises capturing an image stream from the user facing camera and analyzing the image stream to detect the eye.

6. The method of claim 1, further comprising
capturing an image of the eye during the exposure; and
authenticating the face using the captured image.

7. The method of claim 6, wherein authenticating comprises identifying an iris for the eye of the face in the captured image and comparing the captured image of the iris to images of authorized users.

8. The method of claim 6, wherein capturing an image of the eye comprises capturing an image of a portion of the face and cropping off the portion that does not include the iris of the eye.

9. The method of claim 1, further comprising determining whether a distance from the face to the IR camera is within a range and wherein illuminating the eye comprises illuminating the eye only if the determined distance is within the range.

10. The method of claim 1, wherein detecting an eye of a face comprises:
showing a view of the user facing camera on a display proximate the user facing camera;
showing an alignment frame in a central area of the display; and
determining when an eye of the face is within the alignment frame.

11. An apparatus comprising:
a user facing camera to detect an eye of a face;
an infrared (IR) camera having a field of view;
a processor to determine a position of the detected eye with respect to the IR camera, wherein the detected eye does not fill the field of view of the IR camera, and to determine a time of exposure by the IR camera for the portion of the IR camera field of view filled by the detected eye; and
an IR lamp to illuminate the eye, the IR lamp activating during the determined time of exposure and deactivating after the determined time of exposure.

12. A portable device comprising:
a display;
a memory;
a user facing camera proximate the display to detect an eye of a face;
an infrared (IR) camera having a field of view;
a processor to determine a position of the detected eye with respect to the IR camera, wherein the detected eye does not fill the field of view of the IR camera, and to determine a time of exposure by the IR camera for the portion of the IR camera field of view filled by the detected eye; and
an IR lamp to illuminate the eye, the IR lamp activating during the determined time of exposure and deactivating after the determined time of exposure,
wherein the processor is further to authenticate the user based on an image of the eye captured during the determined time of exposure and to provide the authenticated user access to the memory.

13. A method comprising:
detecting an eye of a face using a user facing camera;
determining a distance of the detected eye with respect to an infrared (IR) camera;
adjusting a field of illumination of an IR lamp based on the determined distance; and
activating the IR lamp while capturing an image of the eye using the IR camera.

14. The method of claim 13, wherein determining a distance comprises using an autofocus sensor, a proximity sensor, a depth camera, a dual aperture system of a second camera or by measuring the size of an iris of the eye.

15. The method of claim 13, wherein adjusting a field of illumination comprises adjusting a lens between the IR lamp and the eye, adjusting a reflector of the IR lamp, or adjusting the field of illumination to cover only the eye of the detected face.

16. The method of claim 13, wherein detecting an eye of a face comprises:
showing a view of the user facing camera on a display proximate the user facing camera;
showing an alignment frame in a central area of the display; and
determining when an eye of the face is within the alignment frame, and
wherein determining a distance and activating the IR lamp comprise determining the distance and activating the IR lamp after the eye is within the alignment frame.

17. The method of claim 16, wherein the user facing camera is a visible light camera oriented to capture an image that is taller than it is wide and wherein the infrared camera is oriented to capture an image that is wider than it is tall.

18. The method of claim 13, wherein the IR lamp comprises two light sources one for each of two eyes, the method further comprising determining whether an image of both eyes of the face is to be captured and wherein activating the IR lamp comprises activating the two light sources.

19. An apparatus comprising:
a user facing camera to detect an eye of a face;
an infrared camera to capture an image of the detected eye;
an IR lamp to illuminate the detected eye during the image capture of the IR camera;
a sensor to determine a distance of the detected eye with respect to the infrared (IR) camera;
an actuator to adjust a field of illumination of the IR lamp based on the determined distance; and
a processor to activate the IR lamp while capturing an image of the eye using the IR camera.

20. A portable device comprising:
a user facing display;
a user facing camera proximate the display to detect an eye of a face;
an infrared camera to capture an image of the detected eye;
an IR lamp to illuminate the detected eye during the image capture of the IR camera;
a sensor to determine a distance of the detected eye with respect to the infrared (IR) camera;
an actuator to adjust a field of illumination of the IR lamp based on the determined distance; and
a processor to activate the IR lamp while capturing an image of the eye using the IR camera and to authenticate the user for use of the portable device using the captured image of the eye.
